(19) United States
(12) Patent Application Publication
(10) Pub. No.: US 2013/0282891 A1
(43) Pub. Date: Oct. 24, 2013

(54) Resource Usage Pattern Matching

(71) Applicants: Kevin E. Davis, San Antonio, TX (US); Chinh M. Do, Austin, TX (US)

(72) Inventors: Kevin E. Davis, San Antonio, TX (US); Chinh M. Do, Austin, TX (US)

(21) Appl. No.: 13/452,571

(22) Filed: Apr. 20, 2012

(51) Int. Cl. G06F 15/173

(52) U.S. Cl. 709/224

(57) ABSTRACT

A method comprises accessing on an electronic device, measurement information related to the operation of an electronic device under evaluation, dividing the measurement information into time slices, organizing the measurement information into a calendar chart, determining a pattern of measurement information, providing the measurement information associated with the pattern in the calendar chart at the associated time slices, and suppressing measurement information unassociated with the pattern in the calendar chart. The measurement information comprises analysis of measurements of the operation of the electronic device under evaluation. The pattern considers a plurality of the time slices.

### BACKGROUND

The present disclosure relates to information services infrastructure and operations management, and more specifically, to resource usage pattern matching.

From the earliest days of computing, users have been attaching devices together to form networks. Several types of networks include local area networks (LANs), metropolitan area networks (MANs) and wide area networks (WANs). The Internet provides one example of a WAN, which connects millions of computers around the world.

Networks provide users with the capacity of dedicating particular computers to specific tasks and sharing resources such as printers, applications and memory among multiple machines and users. Some computers, commonly known as servers, provide functionality to other computers on a network. Communication among computers and devices on a network is typically referred to as traffic.

Networking and sharing of computers adds a level of complexity that is not present with a single machine, standing alone. A problem in one area of a network, whether with a particular computer or with the communication media that connects the various computers and devices, can cause problems for all the computers and devices that make up the network. For example, a computer such as a file server that provides disk resources to other machines may prevent the other machines from accessing or storing critical data; it thus prevents machines that depend upon the disk resources from performing their tasks. In another example, a computer such as a server that provides processing resources to other machines may prevent the other machines from completing tasks. Network and MIS managers may manage these resources as well as other applications across the networks separating servers from end-users.

### BRIEF SUMMARY

According to one aspect of the present disclosure, a method includes accessing on an electronic device, measurement information related to the operation of an electronic device under evaluation, dividing the measurement information into time slices, organizing the measurement information into a calendar chart, determining a pattern of measurement information, providing the measurement information associated with the pattern in the calendar chart at the associated time slices, and suppressing measurement information unassociated with the pattern in the calendar chart. The measurement information includes analysis of measurements of the operation of the electronic device under evaluation. The pattern considers a plurality of the time slices.

According to another aspect of the present disclosure, a system includes a memory, a processor coupled to the memory, and computer-executable instructions within the memory. The instructions are readable by the processor. The instructions, when read and executed, cause the processor to access measurement information related to the operation of an electronic device under evaluation, divide the measurement information into time slices, organize the measurement information into a calendar chart, determine a pattern of measurement information, provide the measurement information associated with the pattern in the calendar chart at the associated time slices, and suppress measurement information unassociated with the pattern in the calendar chart. The measurement information includes analysis of measurements of the operation of the electronic device under evaluation. The pattern considers a plurality of the time slices.

According to yet another aspect of the present disclosure, a computer program product includes a computer readable storage medium with computer readable program code. The computer readable program code includes computer readable program code configured to access measurement information related to the operation of an electronic device under evaluation, computer readable program code configured to divide the measurement information into time slices, computer readable program code configured to organize the measurement information into a calendar chart, computer readable program code configured to determine a pattern of measurement information, computer readable program code configured to provide the measurement information associated with the pattern in the calendar chart at the associated time slices, and computer readable program code configured to suppress measurement information that is not associated with the pattern in the calendar chart. The measurement information includes analysis of measurements of the operation of the electronic device under evaluation. The pattern considers a plurality of the time slices.

### BRIEF DESCRIPTION OF THE DRAWINGS

Aspects of the present disclosure are illustrated by way of example and are not limited by the accompanying figures with like references indicating like elements.

FIG. 1 illustrates an example embodiment of a system configured to perform resource usage pattern matching;

FIG. 2 illustrates an example embodiment of a measurement chart;

FIG. 3 illustrates an example embodiment of modified chart showing busy hour pattern matching for CPU utilization for a month's worth of days and for one-hour time slices on each such day;

FIG. 4 illustrates an example embodiment of modified chart showing business week patterns for high CPU utilization for CPU utilization for a month's worth of days and for one-hour time slices on each such day;

FIG. 5 illustrates an example embodiment of modified chart showing repeating hours by business day patterns for high CPU utilization for CPU utilization for a month's worth of days and for one-hour time slices on each such day;

FIG. 6 illustrates an example embodiment of a method for resource usage pattern matching;

FIG. 7 illustrates an example embodiment of a method for pattern matching to determine a busy time slice or other most extreme measurement within a time period;

FIG. 8 illustrates an example embodiment of a method for pattern matching to determine a business week pattern within a time period; and

FIG. 9 illustrates an example embodiment of a method for pattern matching to determine a repeating hours by business day pattern within a time period.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

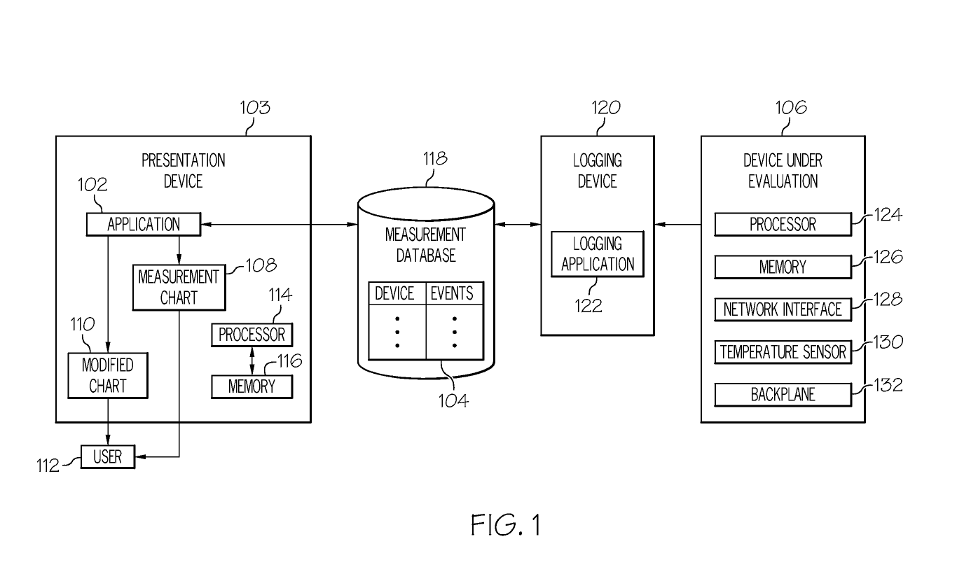

Referring now to FIG. 1, an illustration of example embodiment of a system 100 configured to perform resource usage pattern matching, the system 100 may include an application 102 configured to analyze information such as measurement information 104 regarding an electronic device to be evaluated such as device under evaluation 106. The analysis performed by application 102 on measurement information 104 may include determining whether measurement information includes various patterns. Application 102 may be configured to display measurement information 104 in a visual display such as measurement chart 108. Furthermore, application 102 may be configured to display the results of its analysis on measurement information 104 in a visual display such as modified chart 110. In one embodiment, modified chart 110 may include a modification of measurement chart 108.

In one embodiment, application 102 may be executing on device under evaluation 106. In another embodiment, application 102 may be executing on a different device other than device under evaluation 106, such as presentation device 103. In such an embodiment, application 102 may be communicatively coupled to device under evaluation 106 through a network. In yet another embodiment, application 102 may be communicatively coupled to a source of information containing measurement information 104. For example, application 102 may be communicatively coupled to measurement database 118.

The device on which application 102 executes, such as presentation device 103, may include a processor 114 coupled to a memory 116. The operation of application 102 may include execution of computer program instructions that are stored in memory 116 by processor 114. Processor 114 may include, for example, a system, device, or apparatus configured to interpret or execute program instructions or process data, and may include, without limitation a microprocessor, microcontroller, digital signal processor (“DSP”), application specific integrated circuit (“ASIC”), or any other digital or analog circuitry configured to interpret or execute program instructions or process data. Presentation device 103 may include a general purpose computer, special purpose computer, management server, or other programmable data processing apparatus. Memory 116 may include a computer readable storage medium.

Application 102 may be configured to present information to user 112, which may include a human or computer-based operator such as an administrator of a network including device under evaluation 106. User 112 may receive such information through, for example, visual display locally or remotely, a network transmission, or stored information.

Measurement information 104 may include any suitable information about the operation of device under evaluation 106. The specific information recorded in measurement information 104 may be configurable application 102 or by a user of application 102, and may be dependent upon the resources within device under evaluation 106. For example, measurement data may include data regarding metrics, errors, availability, or environmental aspects of device under evaluation 106. Such metrics may include, for example, utilization of any suitable resource of device under evaluation 106 such as processor 124, memory 126, network interface 128, or backplane 132. The utilization may be expressed in terms of percentage of the available resource. Although a specific number and kind of resources are illustrated in device under evaluation 106, any suitable number and kind of resources may be evaluated. The metrics may also include, for example, information loss, such as packets of information lost during communication utilizing network interface 128. The errors measured in device under evaluation 106 may include, for example, transmission or packet errors between device under evaluation 106 and another entity on a network through network interface 128. Such errors may be the result of a signaling error due to bad cables, interference, faulty interface portions of network interface 128, or software errors. Measurement information 104 regarding availability may include, for example, system uptime for a given time period, time since last reboot, or whether a reboot occurred during a given time period. Environmental measurements may include, for example, temperature of a system, module, processor, or other portion of device under evaluation 106. Although a specific number and kind of measurement information 104 are described, any suitable number and kind of measurement information may be evaluated.

Measurement information 104 may include data, for example, in its raw format or as part of summarizations or evaluations regarding the operation of device under evaluation 106. Furthermore, measurement information 104 may include time information associated with such data. For example, raw data or other events may be marked with a corresponding time stamp, such as “packet received at 02:05 Apr. 20, 2012.” In another example, summary or evaluation data may include a time period for which data has been summarized or evaluated, such as “fifty-seven packets received between 02:00 Apr. 20, 2012 and 03:00 Apr. 20, 2012.”

Measurement information 104 may be stored in any suitable manner. In one embodiment, measurement information 104 may be stored in measurement database 118. Measurement database 118 may be implemented by, for example, a relational database, file, record, data structure, or any other suitable mechanism. Measurement database 118 may organize measurement information 104 according to an associated device. Measurement database 118 may be implemented within any suitable portion of system 100, such as on presentation device 103, logging device 120, as a stand-alone component, or on device under evaluation 106.

System 100 may include a logging application 122 configured to poll, access, query, or otherwise monitor devices for measurement information 104 and to store such information. Logging application 122 may be configured to monitor one or more such devices. Logging application 122 may be implemented by any suitable software, hardware, or combination thereof. In one embodiment, logging application 122 may be resident upon a logging device 120, implemented by any suitable electronic device communicatively coupled to device under evaluation 106. In various other embodiments, logging application 122 may be resident upon, for example, device under evaluation 106 or presentation device 103. Logging application 122 may be configured to gather measurement information from device under valuation 106 and store the information in measurement database 118.

In one embodiment, logging application 122 may be configured to perform preliminary analysis on measurement information 104. Such analysis may include, for example, placing measurement information into discrete categories or divisions, determining maximums, minimums, averages, modes, or percentiles. In another embodiment, such analysis may be conducted by application 102.

Device under evaluation 106 may include any suitable electronic device or information technology asset that is to be managed and monitored by system 100. For example, device under evaluation 106 may include a computer, server, laptop, desktop, router, switch, gateway, software module, hardware module, or computer sub-component. Although a single device under evaluation 106 is shown, system 100 may be configured to monitor many electronic devices.

Application 102 may be configured to analyze measurement information 104. In one embodiment, application 102 may be configured to display such analysis in measurement chart 108. Measurement chart 108 may be implemented by, for example, a graphical display, spreadsheet, table, record, or other data structure.

Measurement chart 108 may be organized in any suitable manner. In a further embodiment, measurement chart 108 may be organized as a calendar chart. Application 102 may be configured to display measurement information 104 with indicators showing discrete ranges, levels, groups, or bands of information. The specific number of ranges and the value of the ranges themselves may be configurable by a user or settings of application 102 through threshold values.

Any suitable manner of expressing the ranges may be used. The ranges may be expressed in the terms used by measurement information 104. For example, a percentage uptime of device under evaluation 106 may be expressed in percentage of seconds within an hour that device under evaluation 106 was available. In another example, the utilization of memory 126 may be expressed as a percentage of memory in use. In such an example, the percentage utilization may be expressed according to a selected time slice.

For time-based presentations of measurement chart 108 such as a calendar chart, any suitable divisions of time may be used. Further, the specific divisions of time may be configurable by settings or by a user of system 100. For example, a plurality of the days of the week may be selected to be shown. In one embodiment, a standard work-week consisting of Monday, Tuesday, Wednesday, Thursday, and Friday may be shown. In another embodiment, a full week including all days of the week may be shown. In yet another embodiment, a user-configured subset of the days of the week may be shown. In another example, time slices of the day may be selected to be shown. In one embodiment, all portions of a day may be shown. In another embodiment, a subset of the day, such as nine am to five pm, may be shown. In yet another example, all the weeks within a given time period may be shown. In one embodiment, all the weeks within a month may be shown. In another embodiment, all the weeks within a quarter may be shown. The number of weeks shown may be user configurable. In still yet another example, the division of time within a given day, such as time slices may be configurable. In one embodiment, the division of time may be given in one-hour increments. In another embodiment, the division of time may be given in fifteen-minute increments.

The data illustrated within a given time slice may be determined through any suitable manner. For example, the data may include a raw data value or a data value summarizing, analyzing, or otherwise derived from multiple data values within the time slice. The mechanism for summarizing, analyzing, or otherwise deriving the data illustrated may be configurable according to settings or a user of system 100. For example, measurement chart 108 may be configured to illustrate average, mode, median, quartile, percentage-level, maximum, or minimum data for the given time slice. In one embodiment, such analysis may be conducted by application 102 upon measurement information 104. In another embodiment, such analysis may be conducted by logging application 102 and stored with measurement information 104.

The data corresponding to a given time slice may be expressed in any suitable mathematical or quantitative manner. In one embodiment, in measurement chart 108 each time slice may display its value. In another embodiment, the possible values for time slices may be divided into a discrete levels, such that each discrete level is represented by, for example, different colors, shades, gradients, or symbols, or numbers. The value of such ranges may be user-configurable. Levels may be selected according to severity. In one example, a heat chart may be chosen with four operating levels such that measurements representing normal operation are represented as green (or a lightest colors), measurements representing increasingly severe operation are represented as yellow and orange (or two successively darker colors), and measurements representing the most severe operations are represented as red (or the darkest color).

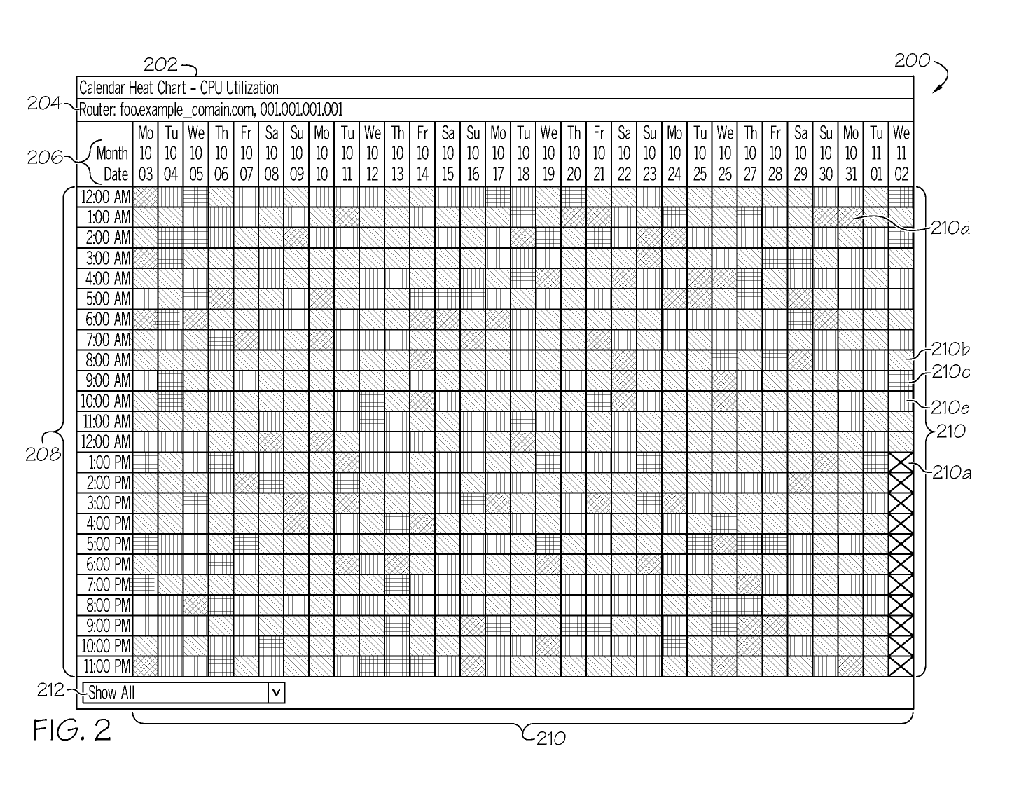

FIG. 2 is an illustration of an example embodiment of a measurement chart 200. In the example of FIG. 2, measurement chart 200 may illustrate a calendar heat chart for a router designated by the server name “foo.example_domain.com” and the Internet Protocol address “001.001.001.001.” Measurement chart 200 may be an example implementation of measurement chart 108.

Measurement chart 200 may include a notation 202 of the type of chart being used and the measurement being illustrated. In the example of FIG. 2, measurement chart 200 may be a heat chart, wherein measurement data 104 are illustrated as belonging to various discrete ranges shown, in increasing severity, in increasingly darker colors. Furthermore, in the example of FIG. 2, measurement chart 200 may be a calendar chart showing measurements over various time periods. In addition, in the example of FIG. 2, measurement chart 200 may illustrate CPU utilization. Such utilization may be of, for example, processor 124 in FIG. 1. Measurement chart 200 may include a designation 204 illustrating for what device measurements are being shown. In the example of FIG. 2, measurement chart 200 may illustrate measurements for the router identified by “foo.example_domain.com” and the Internet Protocol address “001.001.001.001.

Furthermore, measurement chart 200 may include measurements for one more days 206, and one or more time periods 208 within each of those days. Individual measurements 210 may thus correspond to a particular time slice for a particular day.

In the example of FIG. 2, the severity of a given measurement 210 may be designated by the color or shade of the measurement representation. The severity of CPU usage for the router may be thus indicated. As described above, the thresholds for the four discrete groupings of data may be configured by settings or a user. For example, CPU usage less than forty percent (herein referred to as “not severe 210b”) may be designated as the least severe and represented by the green or the lightest shade; CPU usage between forty percent and fifty-five percent (herein referred to as “less severe 210c”) may be the next most severe and represented by yellow or the next darkest shade; CPU usage between fifty-five percent and seventy-five percent (herein referred to as “more severe 210d”) may be the next most severe and represented by orange or the next darkest shade; and CPU usage over seventy-five percent (herein referred to as “most severe 210e”) may be the most sever and represented by red or the darkest shade. Time slices for which there are no measurements may be represented in any suitable way, such as with an “X” 210a.

Measurement chart 200 may include a selector 212 for changing the view of measurement information 104. In the example of FIG. 2, selector 212 may indicate that all available data is to be shown. Changing the view of measurement information 104 with selector 212 may instruct application 102 to conduct or display pattern matching upon the available data. Such pattern matching may result in the display of modified chart 110.

Returning to FIG. 1, application 102 may be configured to conduct pattern matching on measurement information 104. In one embodiment, the pattern matching may be based upon the raw data of measurement information 104. In another embodiment, the pattern matching may be based upon analysis, summarizations, or other information derived from measurement information 104. Such analysis may include, for example, mean, mode, median, maximum, quartile, percentage-level, or minimum values for a given time period. Percentage-level values may include, for example, an ordering of values with the given time period and selection of the value whose index corresponds to the designated percentage. A specific example may include fifty values within a time slice which are ordered from least to greatest. The sixty-eighth-percent-value may be the measurement value at index thirty-four.

Any suitable pattern matching may be used. In one embodiment, a busy time slice pattern may be determined and displayed. For example, only time slices with a maximum measurement within a given day may be determined and displayed. In another embodiment, a business week pattern may be determined and displayed. For example, only time slices associated with a time of day which typically experiences measurements above a threshold may be determined and displayed. In yet another embodiment, repeating busy hours may be determined and displayed. For example, only time slices associated with a time of day on a particular day of the week which typically experiences measurements above a threshold may be determined and displayed. In various embodiments, such determinations may be made given a five-day week, seven-day week, or user-customized week. In various other embodiments, such determinations may be made give a twenty-four-hour day or user-customized hours per day.

Application 102 may be configured to conduct pattern matching and display or record the result. The result may be included within modified chart 110, which may be stored or displayed to user 112. Modified chart 110 may be implemented in similar fashion to measurement chart 108, but with modifications to the measurements displayed therein.

The selection of pattern matching to be used, as well as criteria for the pattern matching, may be provided by settings or a user of application 102. In one example, a user of measurement chart 108 or modified chart 110 may use a selector to switch analysis and views.

In one embodiment, application 102 may be configured to determine a busy time slice pattern from measurement information 104. Application 102 may be configured to determine, for a configurable time period, which time slice within the time period had a most extreme value. Such an extreme value may be, for example, a maximum or minimum. The selection of a maximum or minimum may be configurable. In one embodiment, the time period may be a calendar day. Other data points not corresponding to the designated extreme value may be suppressed in the resulting modified chart 110. The original data points representing the designated extreme value may be preserved in the resulting modified chart 110.

A user of system 100 may readily determine the most extreme measurements for a given time period by accessing modified chart 110. A user, such as user 112, may then determine the time and the severity of the most extreme measurement. Such an extreme measurement may be designated as a “busy time” for example measurements such as processor, memory, or network utilization. Other extreme measurements may be similarly made for errors, uptime, downtime, availability, or loss.

If on a given day's period measurement chart 108 indicated multiple “most severe” 210e measurements, modified chart 110 applying this pattern matching would thus only display the measurement from the “most severe” 210e measurement with the highest value. Similarly, if on a given day's period measurement chart 108 indicated multiple “more severe” 210d measurements (but now “most severe” 210e measurements), modified chart 110 applying this pattern matching would thus only display the measurement from the “more severe” 210d measurement with the highest value. Such behavior would apply similarly to measurements falling only within the “not severe” 210b or “less severe” 210c categories. Consequently, modified chart 110 may disambiguate similar data to illustrate patterns within measurement chart 108. An indication that the highest reading of a given time period was “not severe” 210b or “less severe” 210c may indicate overprovisioning.

The time periods to be illustrated or pattern-matched by application 102 may be configured by settings or user 112. In one embodiment, all time periods may be selected for such analysis. In another embodiment, a subset of the time periods may be selected. Such a subset may be selected, for example, to avoid known downtime, maintenance, program launch, or other factors for which data will be discarded from the pattern matching.

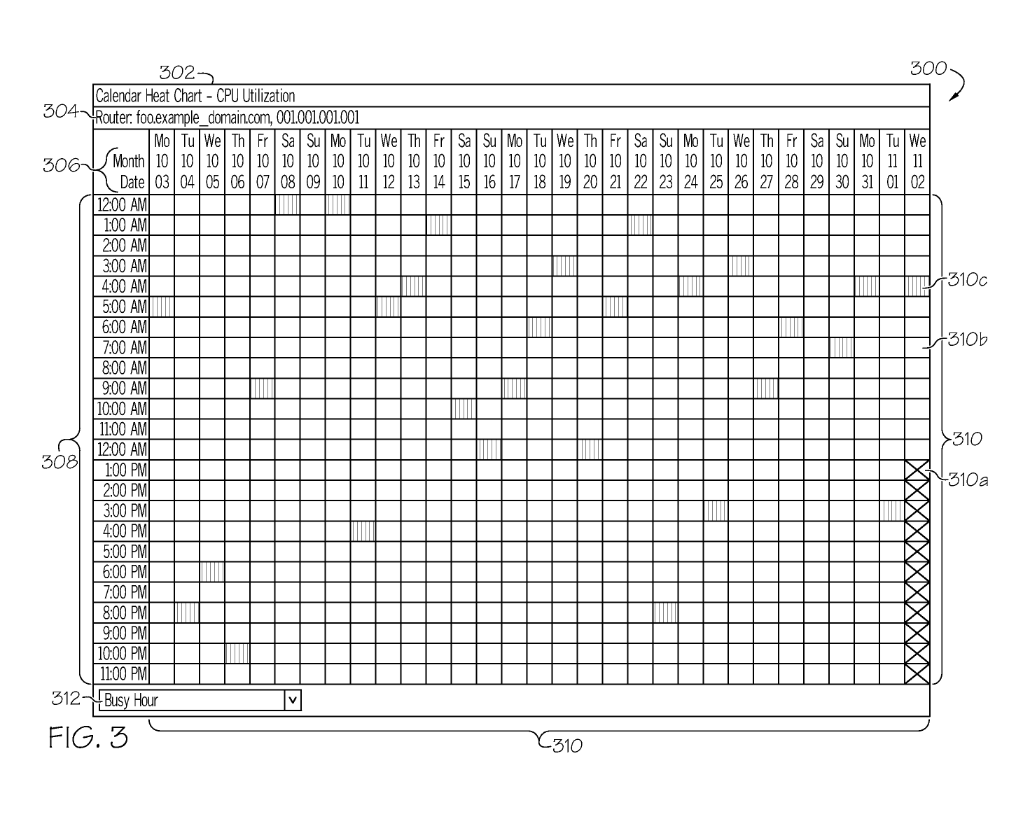

FIG. 3 is an illustration of an example embodiment of modified chart 300 illustrating busy hour pattern matching for CPU utilization for a month's worth of days and for one-hour time slices on each such day. Modified chart 300 may be an example implementation of modified chart 110.

Modified chart 300 may include a notation 302, designation 304, days 306, time periods 308, severity levels, and selector 312 implemented in similar fashion to notation 202, designation 204, days 206, time periods 208, severity levels, and selector 212 of FIG. 2.

Modified chart 300 may be configured to only display the highest measurement 310c within a given day. These measurements may be “not severe,” “less severe,” “more severe,” or “most severe” as provided by the individual data. In one embodiment, the display of each such highest measurement 310c may continue to reflect the quantitative or qualitative indication of the underlying data through, for example, shading, symbols, or other indicators. In the example of FIG. 3, each of the displayed highest measurements 310c may be “most severe.” All other measurements may be suppressed. Suppressed measurements 310b may be “not severe,” “less severe,” “more severe,” or “most severe” as provided by the individual data. In the example of FIG. 3, suppressed measurements 310b may include a plurality of each such category. Consequently, modified chart 300 may display a pattern of the highest values of time slices within a designated time period, such as the busiest hour of a day across various days.

Unrecorded elements 310a may be configured to illustrate a lack of information for a given time slice. Selector 312 may be configured to illustrate the pattern matching applied to the data, such as “Busy Hour.”

Returning to FIG. 1, in another embodiment, application 102 may be configured to determine and display a business week pattern from measurement information 104. Application 102 may be configured to determine, for a configurable time period such as a one-hour time slice, whether a threshold value has been surpassed during the time period on a configurable threshold number of days of a configurable business week.

The threshold value may include, for example, a threshold maximum or minimum. The selection of the threshold maximum or minimum may be configurable in terms of raw data such as a measurement, information derived from raw data such as an average measurement, or a user-defined range or categorization, such as a severe average measurement. In one embodiment, one-hour time slices may be used.

The configurable time period may include a configurable amount of time, such as a one-hour or fifteen-minute time slice, within a configurable portion of a given day, such as twenty-four hours or any time excepting two AM to four AM. Such a configuration may reflect normal maintenance, backup, application launch, or other special times for which pattern matching will not be conducted. In one embodiment, a full twenty-four hour period may be selected.

The configurable business week may include all seven days of the week or a subset thereof. Such a configuration may reflect days of interest for which pattern matching will be conducted. Days not selected may include days on which regular maintenance, backup, application launch, or other special operations for which pattern matching will not be conducted. In one embodiment, a business week or business days of Monday through Friday may be selected.

The configurable threshold number of days may include a percentage or absolute number of days within the business week on which measurements at the same given time slice surpass the defined threshold. In one embodiment, the configurable threshold number of days may include a threshold of fifty percent of the defined business week, above which application 102 may determine a business week pattern match. For example, if a measurement is “severe” at 2:00 pm on three out of five defined business days, application 102 may determine a business week pattern match. In another example, if such a measurement exists for a given time slice on four days wherein all seven days are designated as business days, application 102 may determine a business week pattern match. Other example criteria may include four out of five defined business days, five out five defined business days, or five out of seven defined business days.

In one embodiment, application 102 may be configured to determine a business week pattern match for the days (Monday, Tuesday, etc.) for a configured business week. As described above, a configured business week may include all seven days of the week or a subset thereof. Selection of a subset for the configured business week may be used, for example, to avoid pattern matching on times where known maintenance, backup, or other services are performed that do not reflect usage that is to be monitored.

For a given matched business week pattern, application 102 may be configured to display each measurement for the corresponding time slice for each day of the business week in modified chart 110. In one embodiment, application 102 may be configured to display such measurements in modified chart 110 as they were displayed in measurement chart 108. For example, measurements within the matched pattern displayed as “most severe,” “more severe,” “less severe,” or “not severe” will continue to be displayed as such. The measurements displayed in the matched pattern may include one or more measurements not reaching the configured measurement threshold, as a requisite number of other measurements within the same time slice on other days may be reached the configured measurement threshold.

In another embodiment, application 102 may be configured to suppress, hide, mask, or otherwise not display measurements not appearing within a matched pattern. Such measurements may include one or more measurements that reached the configured measurement threshold, but appeared in a time slice for which a requisite number of other measurements did not reach the configured measurement threshold.

A user of system 100 may readily determine what time of day a threshold measurement is typically made within a business week by accessing modified chart 110. A user, such as user 112, may then be able to determine on what time of day severe measurements are most likely. Severe measurements may include high utilization for example resources such as processor, memory, or networks, or high amounts of errors, uptime, downtime, availability, or loss. The indication of severe measurements at a particular time of the day on a certain number of days in a given week may provide troubleshooting information for determining a source of the severe measurements, such as a process kicking off at a specific time daily.

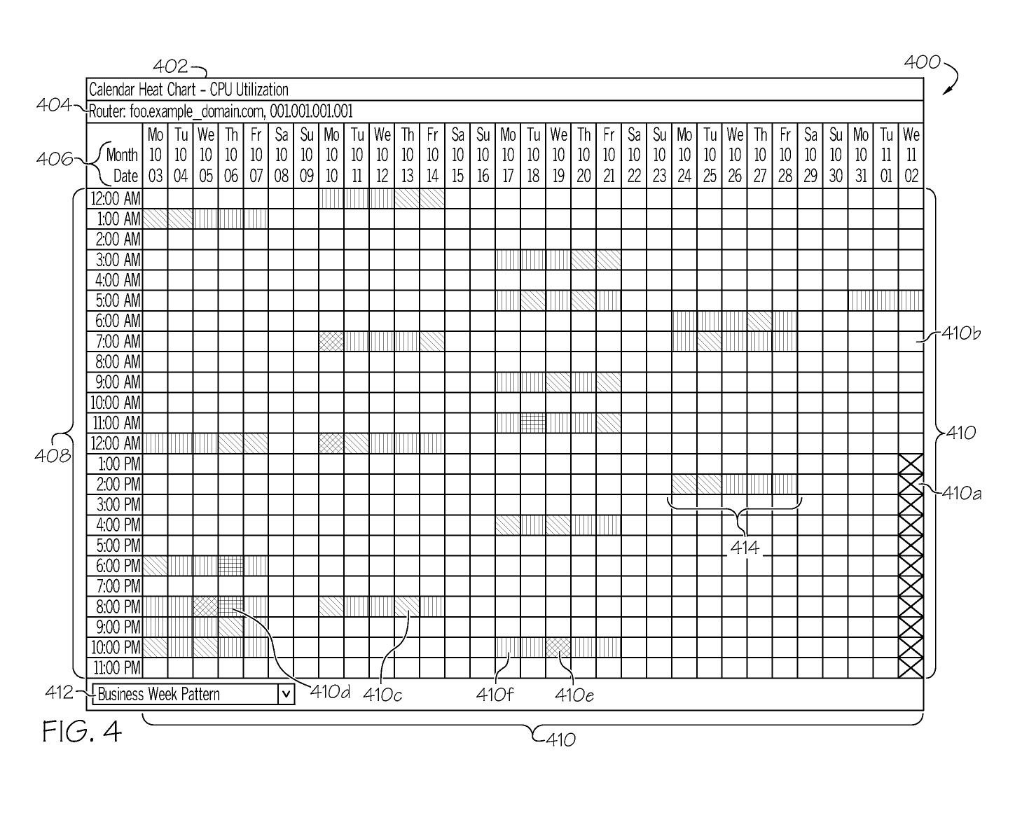

FIG. 4 is an illustration of an example embodiment of modified chart 400 illustrating business week patterns for high CPU utilization for CPU utilization for a month's worth of days and for one-hour time slices on each such day. Modified chart 400 may be an example implementation of modified chart 110.

Modified chart 400 may include a notation 402, designation 404, days 406, time periods 408, severity levels, and selector 412 implemented in similar fashion to notation 202, designation 204, days 206, time periods 208, severity levels, and selector 212 of FIG. 2.

Severity may be marked in modified chart 400 as not recorded 410a, “not severe” 410c, “less severe” 410d, “more severe” 410e, and “most severe” 410f. Such severity indications may be consistent with those shown in FIG. 2.

Modified chart 400 may be configured to only display time slices corresponding to times within a given week in which at least three measurements are determined to be “most severe.” A given business week pattern, such as pattern 414, may include the corresponding time slices for each and every day within the same business week. In pattern 414, Monday, October 24 and Tuesday, October 25 are denoted as “more severe” 410e and thus may not meet the threshold criteria for an individual measurement, but nonetheless are displayed and included within pattern 414 because Wednesday, October 26; Thursday, October 27; and Friday, October 28 each are denoted as “most severe” 410f and thus meet the threshold criteria.

Other measurements not within such matching patterns may be concealed, suppressed, masked, or otherwise not displayed, such as suppressed measurement 410b. Such suppressed measurements 410b may have otherwise met the threshold criteria for an individual measurement and been “most severe.” Furthermore, each such suppressed measurement 410b may be “not severe,” “less severe,” or “more severe.”

Even if data is incomplete for a given week, if a requisite number of time slices across the days of the week for which data is available exceed the threshold number of days, then the pattern may be considered to be matched. For example, the time slice of five AM on Monday, October 31; Tuesday, November 1; and Wednesday, November 2 may represent a “most severe” measurement. Thus, the week's worth of time slices may be determined to match the pattern, even though data is unavailable for the subsequent two days.

Modified chart 400 is shown as implementing a Monday to Friday business week, for which three days' worth of measurements exceeding a threshold at the same time slice each day may trigger a matching pattern. Any suitable combination of the days of the week may be used for the business week. Further, any suitable subset of those days may be used as criteria for triggering the matching pattern. In addition, any suitable threshold for individual time slices may be used when evaluating the time across the days of the business week. These may be configurable by a user of modified chart 400.

Consequently, modified chart 400 may display a pattern of the time slices for an entire business week when a designated number of days within the business week reach a threshold value. Such a pattern may be useful for determining recurring conditions within measurement data. Such recurring conditions may occur daily or nearly daily.

Unrecorded elements 410a may be configured to illustrate a lack of information for a given time slice. Selector 412 may be configured to illustrate the pattern matching applied to the data, such as “Business Week Pattern.”

Returning to FIG. 1, in another embodiment, application 102 may be configured to determine and display a repeating hours by business day pattern from measurement information 104. Application 102 may be configured to determine, for a configurable time period such as a one-hour time slice, whether a threshold value has been surpassed during the same time period on a configurable threshold number of the different instances of the same day of the week within a designated number of days. For example, application 102 may evaluate the measurements of the 4:00 am time slices of every Friday to see if the measurement of at least three such time slices exceeds a threshold value. If so, application 102 may be configured to match the pattern as Friday, 4:00 am. The days of the week to be considered may include a configurable business week.

The threshold value may include, for example, a threshold maximum or minimum. The selection of the threshold maximum or minimum may be configurable in terms of raw data such as a measurement, information derived from raw data such as an average measurement, or a user-defined range or categorization, such as a severe average measurement. In one embodiment, one-hour time slices may be used.

The configurable time period may include a configurable amount of time, such as a one-hour or fifteen-minute time slice, within a configurable portion of a given day, such as twenty-four hours or any time excepting two AM to four AM. Such a configuration may reflect normal maintenance, backup, application launch, or other special times for which pattern matching will not be conducted. In one embodiment, a full twenty-four hour period may be selected.

The configurable business week may include all seven days of the week or a subset thereof. Such a configuration may reflect days of interest for which pattern matching will be conducted. Days not selected may include days on which regular maintenance, backup, application launch, or other special operations for which pattern matching will not be conducted. In one embodiment, a business week or business days of Monday through Friday may be selected.

The designated number of days may include a configurable set of days, such as a month or a quarter-year. The days may be consecutive or non-consecutive.

The configurable threshold number of days may include a percentage or absolute number of a given day of the week within the designated number of days on which measurements at the same given time slice surpass the defined threshold. In one embodiment, the configurable threshold number of days may include a threshold of fifty percent of the designated number of days, above which application 102 may determine a repeating hours by business day pattern match. For example, if a measurement is “severe” at 2:00 pm on three out of five Mondays within a given month, application 102 may determine a repeating hours by business day pattern match. In another example, if such a measurement exists for a given time slice on any six Tuesdays within a give quarter, application 102 may determine a repeating hours by business day pattern match. Other example criteria may include all slices for a given day (Monday, Tuesday, etc.) in a month or quarter, three slices for a given day (Monday, Tuesday, etc.) in a month or quarter, or a majority of given days (Monday, Tuesday, etc.) for which data is available.

In one embodiment, application 102 may be configured to determine a repeating hours by business day pattern match for the days (Monday, Tuesday, etc.) for a configured business week. As described above, a configured business week may include all seven days of the week or a subset thereof. Selection of a subset for the configured business week may be used, for example, to avoid pattern matching on times where known maintenance, backup, or other services are performed that do not reflect usage that is to be monitored.

For a repeating hours by business day pattern match, application 102 may be configured to display each measurement for the corresponding time slice for each day of the business week in modified chart 110. In one embodiment, application 102 may be configured to display such measurements in modified chart 110 as they were displayed in measurement chart 108. For example, measurements within the matched pattern displayed as “most severe,” “more severe,” “less severe,” or “not severe” will continue to be displayed as such. The measurements displayed in the matched pattern may include one or more measurements not reaching the configured measurement threshold, as a requisite number of other measurements within the same time slice on other days may be reached the configured measurement threshold.

In another embodiment, application 102 may be configured to suppress, hide, mask, or otherwise not display measurements not appearing within a matched pattern. Such measurements may include one or more measurements that reached the configured measurement threshold, but appeared in a time slice for which a requisite number of other measurements did not reach the configured measurement threshold.

A user of system 100 may readily determine what time of day and what day of the week a threshold measurement is typically made a month or quarter by accessing modified chart 110. A user, such as user 112, may then be able to determine on what time of day and what day of the week severe measurements are most likely. Severe measurements may include high utilization for example resources such as processor, memory, or networks, or high amounts of errors, uptime, downtime, availability, or loss. The indication of severe measurements at a particular time of the day and day of the week may provide troubleshooting information for determining a source of the severe measurements, such as a process kicking off at a specific time and day of the week.

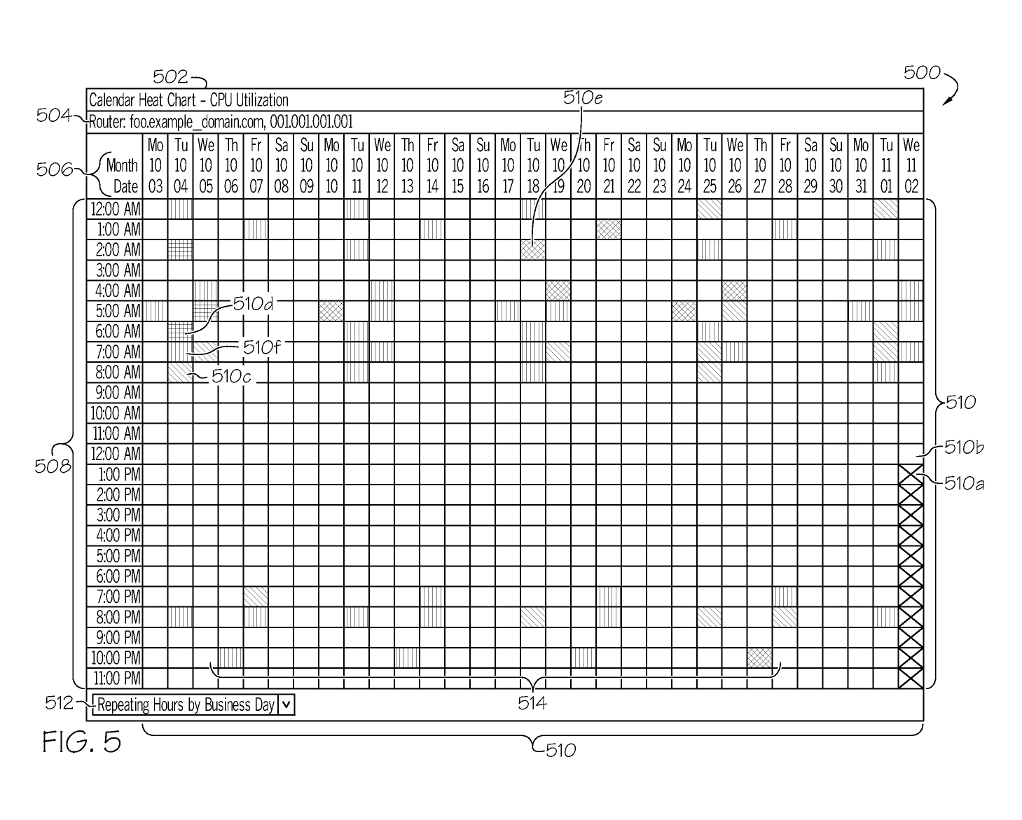

FIG. 5 is an illustration of an example embodiment of modified chart 500 illustrating repeating hours by business day patterns for high CPU utilization for CPU utilization for a month's worth of days and for one-hour time slices on each such day. Modified chart 500 may be an example implementation of modified chart 110.

Modified chart 500 may include a notation 502, designation 504, days 506, time periods 508, severity levels, and selector 512 implemented in similar fashion to notation 202, designation 204, days 206, time periods 208, severity levels, and selector 212 of FIG. 2.

Severity may be marked in modified chart 500 as not recorded 510a, “not severe” 510c, “less severe” 510d, “more severe” 510e, and “most severe” 510f. Such severity indications may be consistent with those shown in FIG. 2.

Modified chart 500 may be configured to only display time slices corresponding to times within days of the week in which at least three measurements for the time slice across all of the instances of the given day of the week are determined to be “most severe.” A given repeating hours by business day, such as pattern 514, may include the corresponding time slices for each and every instance of the business day within, for example, the month or quarter. In pattern 514, each time slice for Thursdays at 10:00 pm is included. Thursday, October 27, 10:00 pm time slice is denoted as “less severe” 510d and thus may not meet the threshold criteria for an individual measurement, but nonetheless is displayed and included within pattern 514 because Thursday, October 6, 10:00 pm; Thursday, October 13, 10:00 pm; and Thursday, October 20, 10:00 pm each are denoted as “most severe” 410f and thus meet the threshold criteria.

Other measurements not within such matching patterns may be concealed, suppressed, masked, or otherwise not displayed, such as suppressed measurement 510b. Such suppressed measurements 510b may have otherwise met the threshold criteria for an individual measurement and been “most severe.” Furthermore, each such suppressed measurement 510b may be “not severe,” “less severe,” or “more severe.”

Even if data is incomplete for a given month or quarter, if a requisite number of time slices for a given day of the week for which data is available exceed the threshold number of days, then the pattern may be considered to be matched.

Modified chart 500 is shown as implementing a Monday to Friday business week, for which three instances of measurements exceeding a threshold at the same time slice on a given day of the week (Monday, Tuesday, etc.) may trigger a matching pattern. Any suitable combination of the days of the week may be used for the business week and the remainder ignored. In addition, any suitable threshold for instances of individual time slices may be used when evaluating the time slices. These may be configurable by a user of modified chart 500.

Consequently, modified chart 500 may display a pattern of the time slices for a given day of the week and time when a designated number of such time slices reach a threshold value. Such a pattern may be useful for determining recurring conditions within measurement data.

Unrecorded elements 410a may be configured to illustrate a lack of information for a given time slice. Selector 412 may be configured to illustrate the pattern matching applied to the data, such as “Business Week Pattern.”

Returning to FIG. 1, in operation, device under evaluation 106 may be executing and using various resources such as processor 124, memory 126, network interface 128, and backplane 132 and generating environmental conditions such as temperature to be sensed by temperature sensor 130. Various measurements, such as utilization, loss, errors, availability, and environmental factors may be made based on such operation. Such measurements may be conducted, for example, by device under evaluation 106 or logging application 122. Logging application 122 may periodically or continually poll the operation of device under evaluation 106 to make such measurements. Logging application 122 may store the raw data as a result of the measurements in measurement information 104. In one embodiment, logging application 122 may conduct preliminary analysis on the data, such as determining maximums, minimums, means, modes, medians, quartiles, or percentiles for a given time slice. In another embodiment, application 102 may conduct such analysis. Logging application 122 may store the analysis in measurement information 104. Logging application 122 may be executing on presentation device 103, logging device 120, or device under evaluation 106.

Measurement information 104 may contain the results of the measurements of device under evaluation 106. Measurement information 104 may be resident within measurement database 118, which in turn may be resident on, for example, a stand-alone device, presentation device 103, logging device 120, or device under evaluation 106.

Application 102 may be operating on, for example, presentation device 103, logging device 120, or device under evaluation 106. Using settings or input from user 112, application 102 may access measurement information 104 and subsequently analyze it for patterns. Application 102 may compile, produce, display, or store measurement chart 108 based upon measurement information 104. As described above, FIG. 2 illustrates an example embodiment of a measurement chart. Furthermore, application 102 may determine whether measurement information 104 includes certain defined patterns and, if so, compile, produce, display, or store modified chart 110 based on such patterns. In one embodiment, modified chart 110 may be a modification of measurement chart 108.

Application 102 may determine whether measurement information 104 includes a pattern for an extreme daily time slice measurement. To make such a determination, application 102 may determine, for a configurable range of time slices within a given day, the time slice corresponding to a most extreme measurement. Such a most extreme measurement may correspond to, for example, the highest or lowest utilization, loss, errors, availability, or environmental factor. The most extreme measurement within a given day may match the pattern and be displayed in modified chart 110. Other measurements from the same given day, although perhaps represented in measurement chart 108 as equivalent to the extreme measurement, may be hidden. As described above, FIG. 3 illustrates an example embodiment of a modified chart for such a pattern.

Application 102 may determine whether measurement information 104 includes a business week pattern for time slice measurements across the days of a given defined business week. To make such a determination, application 102 may determine, for a configurable range of time slices on a configurable set of the days of the week (a configurable business week), whether a configurable number of time slices corresponds to measurements exceeding a threshold amount. The measurements may correspond to, for example, utilization, loss, errors, availability, or environmental factors. If, for the configured number of days of the configured business week, the measurements of the same time slice for each such day exceed the threshold, the application 102 may determine that the time slice for the given week matches the pattern.

The corresponding time slice for each day of the configured week may be included within the matched pattern regardless of whether or not an individual such time slice exceeded the threshold. Time slices within the pattern may retain designations, markings, or other indicators of their value, such as those present in conjunction with measurement chart 108. Further, application 102 may suppress, discard, mask, or hide all other time slices that are not a part of a matched pattern. Such time slices may be suppressed regardless of whether or not an individual time slice exceeded the threshold. As described above, FIG. 4 illustrates an example embodiment of a modified chart for such a pattern.

Application 102 may determine whether measurement information 104 includes a repeating hours by business day pattern for time slice measurements for a given day of the week (Monday, Tuesday, etc.) across the days of a time period such as a month or quarter. To make such a determination, application 102 may determine, for a configurable range of time slices on a configurable set of the days of the week (a configurable business week), whether a configurable number of time slices of a particular time and day of the week (Monday, Tuesday, etc.) corresponds to measurements exceeding a threshold amount. The measurements may correspond to, for example, utilization, loss, errors, availability, or environmental factors. If, for the configured number of days of the time period, the measurements of the same time slice for each such time and day of the week (Monday, Tuesday, etc.) exceed the threshold, the application 102 may determine that the time slice for the given week matches the pattern.

The corresponding time slice for each time and day of the week (Monday, Tuesday, etc.) may be included within the matched pattern regardless of whether or not an individual such time slice exceeded the threshold. Time slices within the pattern may retain designations, markings, or other indicators of their value, such as those present in conjunction with measurement chart 108. Further, application 102 may suppress, discard, mask, or hide all other time slices that are not a part of a matched pattern. Such time slices may be suppressed regardless of whether or not an individual time slice exceeded the threshold. As described above, FIG. 5 illustrates an example embodiment of a modified chart for such a pattern.

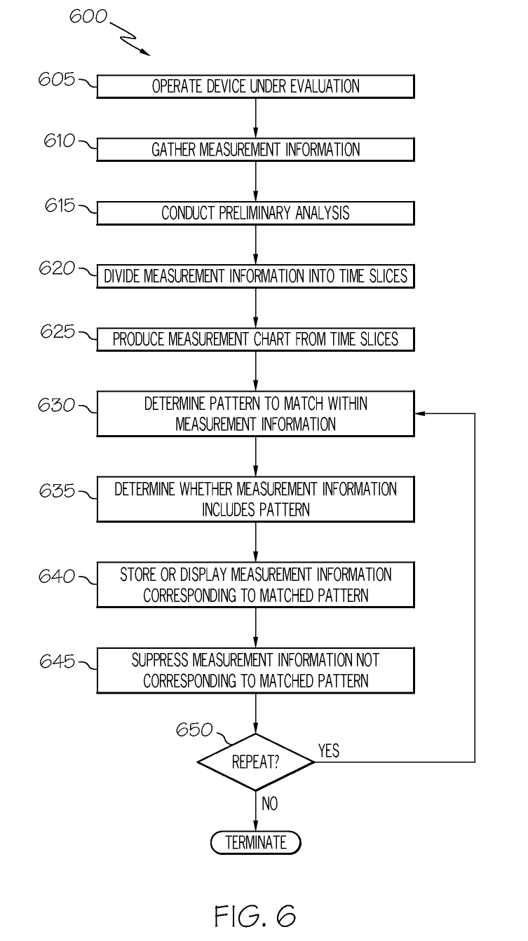

FIG. 6 is an illustration of an example method 600 for resource usage pattern matching. In step 605, a device under evaluation may be operated, generating any suitable number and kind of conditions, such as utilization, loss, errors, availability, or environmental variables. In one embodiment, the conditions may be related to resources on the device such as processors, network interfaces, memories, backplanes, or other components. In step 610, measurements may be made concerning the conditions generated by the device under evaluation. Such measurements may be conducted through polling the device under evaluation. The measurements may be, for example, recorded, stored, or transmitted.

In step 615, preliminary analysis may be conducted on the measurement information. For example, such analysis may include determining, for a given time slice, maximums, minimums, means, modes, medians, percentiles, or quartiles. The granularity of the time slice may be configurable. In one embodiment, the time slice may correspond to one hour of operation, initiating at the top of a given hour. The start, end, or offsets of the time slice may likewise be configurable. The results of the analysis may be recorded, stored, or transmitted. Subsequent pattern matching may be conducted upon measurement information itself, or the measurement information in conjunction with the analysis in step 615. In step 620, the measurement information may accordingly be divided into the determined time slices.

In step 625, a measurement chart may be produced, stored, or displayed from the measurement data and associated analysis, incorporating the selected time slices. The measurement chart may illustrate resource usage. The production of the measurement chart may be in response to settings or user input.

In step 630, a pattern to be matched within the measurement information may be determined. Any suitable pattern may be detected, such as a busy time pattern, business week pattern, or repeating hours by business day pattern. Step 630 may be conducted in response to settings or user input indicating the initiation and type of pattern-matching to be conducted.

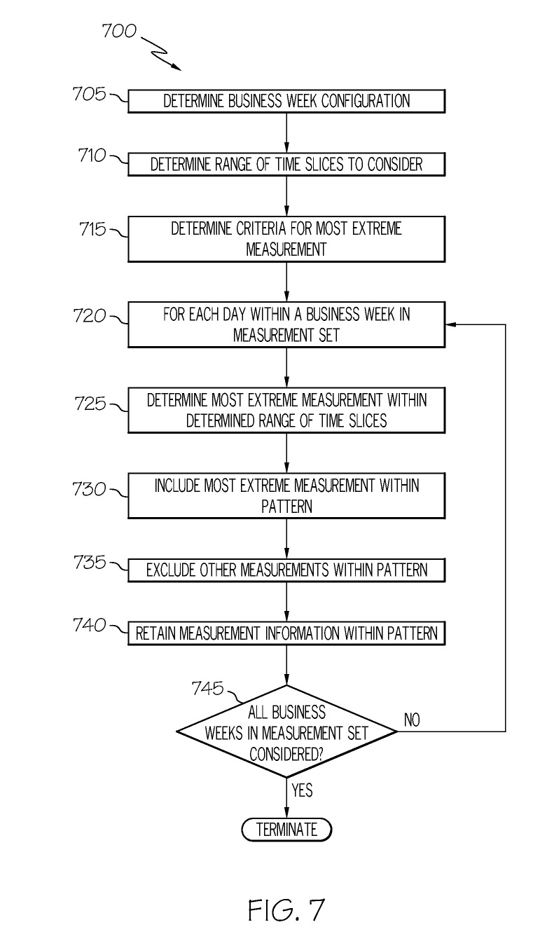

In step 635, it may be determined whether the selected pattern to be matched is contained within the measurement information. Step 635 may be implemented fully or in part by methods 700, 800, or 900 of FIGS. 7-9. If one or more such patterns are matched, then in step 640 the measurement information associated with the matching patterns may be stored or displayed in, for example, a modified chart. The measurement information that is stored or displayed may be presented in similar fashion to the presentation of the same information in an original measurement chart. For example, indications of the value of the measurement may persist in the modified chart. For measurement information not associated with any matched pattern, the information may be suppressed, masked, hidden, or otherwise concealed.

In step 650, it may be determined whether any subsequent pattern matching is to be conducted. If so, method 600 may return to step 630, 605, or other suitable previous step to repeat the steps of gathering information, analyzing it, or conducting pattern matching. If not, method 600 may terminate.

FIG. 7 is an illustration of an example embodiment of a method 700 for pattern matching to determine a busy time slice or other most extreme measurement within a time period. In one embodiment, such a time period may include a day. Method 700 may implement fully or in part step 635 of FIG. 6. In step 705, a business week to be used in the pattern matching of method 700 may be determined. The business week may define the set of days of the week that are to be included within the pattern matching. For example, Monday through Friday, Monday through Saturday, or all seven days of the week may be selected. The selection of the business week may be performed according to resource usage that is to be analyzed with pattern matching.

In step 710, a range of time slices to be considered in the pattern matching of method 700 may be determined. For example, all the time slices within a twenty-four hour period beginning at midnight on a given day may be used. In another example, the time slices from midnight to 2:00 am, and the time slices from 4:00 am to midnight may be used.

In step 715, criteria for evaluating the measurements or analysis associated with individual time slices may be determined. Such criteria may include, for example, a high or low threshold, beyond which the time slice may be considered for pattern matching. In one embodiment, step 715 may include criteria for the most extreme—such as the highest or lowest—measurement within the range of time slices.

In step 720, a series of steps may be conducted for each day within a given business week (as configured in step 705) in a measurement set. Such steps may include steps 725-740.

In step 725, it may be determined what the most extreme measurement is within the determined range of time slices. The range may include the range determined in step 710. In step 730, the most extreme measurement and associated time slice may be included within the matched pattern. In step 735, all other measurements within the range may be excluded from the matched pattern. In step 740, the measurement information associated with the matched time slice may be retained or preserved.

In step 745, it may be determined whether all business weeks within a measurement set to be evaluated have been considered. If so, method 700 may terminate. If not, method 700 may repeat beginning at, for example, step 720 and evaluating another business week.

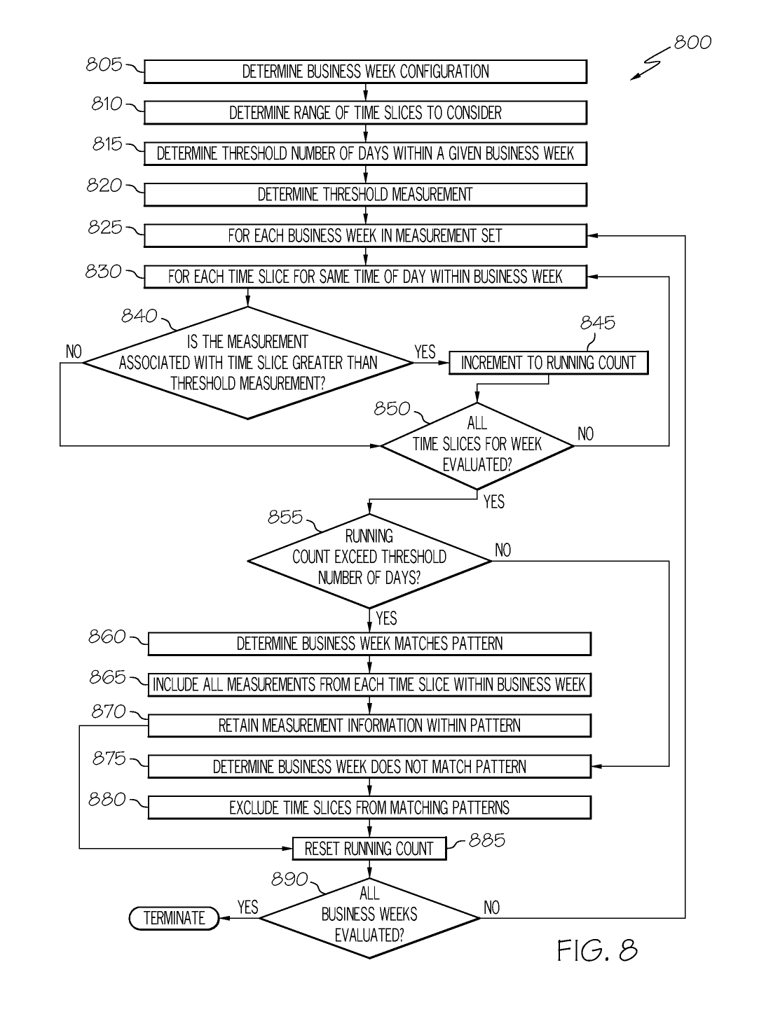

FIG. 8 is an illustration of an example embodiment of a method 800 for pattern matching to determine a business week pattern within a time period. In one embodiment, such a time period may include a month. Method 800 may implement fully or in part step 635 of FIG. 6. In step 805, a business week configuration to be used in the pattern matching of method 800 may be determined. The business week may define the set of days of the week that are to be included within the pattern matching. For example, Monday through Friday, Monday through Saturday, or all seven days of the week may be selected. The selection of the business week may be performed according to resource usage that is to be analyzed with pattern matching.

In step 810, a range of time slices to be considered in the pattern matching of method 800 may be determined. For example, all the time slices within a twenty-four hour period beginning at midnight on a given day may be used. In another example, the time slices from midnight to 2:00 am, and the time slices from 4:00 am to midnight may be used.

In step 815, a threshold number of days within a given business week may be determined. Such a threshold may define, for a common time slice among the days of the individual business week, how many of such days must include a threshold measurement level at the common time slice in order for the business week to match the pattern searched for in method 800. The threshold may be defined in absolute or relative terms, and may include all or a subset of such days.

In step 820, a threshold measurement for evaluating the measurements or analysis associated with individual time slices across such days may be determined. Such a threshold may include, for example, a high or low threshold, beyond which the time slice may be considered for pattern matching. In one embodiment, step 820 may include criteria that the measurement reaches a highest or most severe grouping of measurement values, such as “most severe.”

In step 825, a series of steps may be conducted for each business week within a measurement set. Such steps may include steps 830-890. One result of an iteration of step 825 may be a determination of whether or not the business week matches the pattern searched for by method 800 for one or more time slices common to each day of the business week.

In step 830, a series of steps may be conducted for each time slice on each day of the configured business week. Such steps may include steps 840-890, which may be repeated for the same time slice on each day of the configured business week. Thus, given a time slice on a given day, in step 840, it may be determined whether the measurement associated with the time slice exceeds the threshold measurement. If so, then in step 845 a running count of such time slices may be incremented. If not, then method 800 may proceed to step 850.

In step 850, it may be determined whether or not the same time slice has been evaluated for each day within the configured business week. If not, the method 800 may return to step 840 to evaluate the time slice corresponding to the same time on a subsequent day of the configured business week. If so, then in step 855 it may be determined whether the running count of time slices has exceeded the threshold number of days, as determined in step 815. If not, then method 800 may proceed to step 875. If so, then in step 860 it may be determined that the business week matches the pattern for the daily time associated with the time slices.

In step 865, all measurements associated with each such time slice across each day of the configured business week may be included within the matched pattern. In step 870, measurement information for each such time slice may be retained, whether or not a given time slice measurement exceeded the measurement threshold. Method 800 may proceed to step 885.

In step 875, it may be determined that the business week does not match the pattern for the daily time associated with the time slices. In step 880, measurement information for each such time slice may be excluded, suppressed, masked or otherwise kept out of the matching pattern. Such a step may be conducted whether or not a given time slice measurement exceeded the measurement threshold.

In step 885, the running count may be reset. If necessary, steps 830-885 may be repeated for other sets of time slices within the business week, each set corresponding to a common time. In step 890, it may be determined whether all business weeks have been evaluated. If not, method 800 may return to step 825. If so, method 800 may terminate.

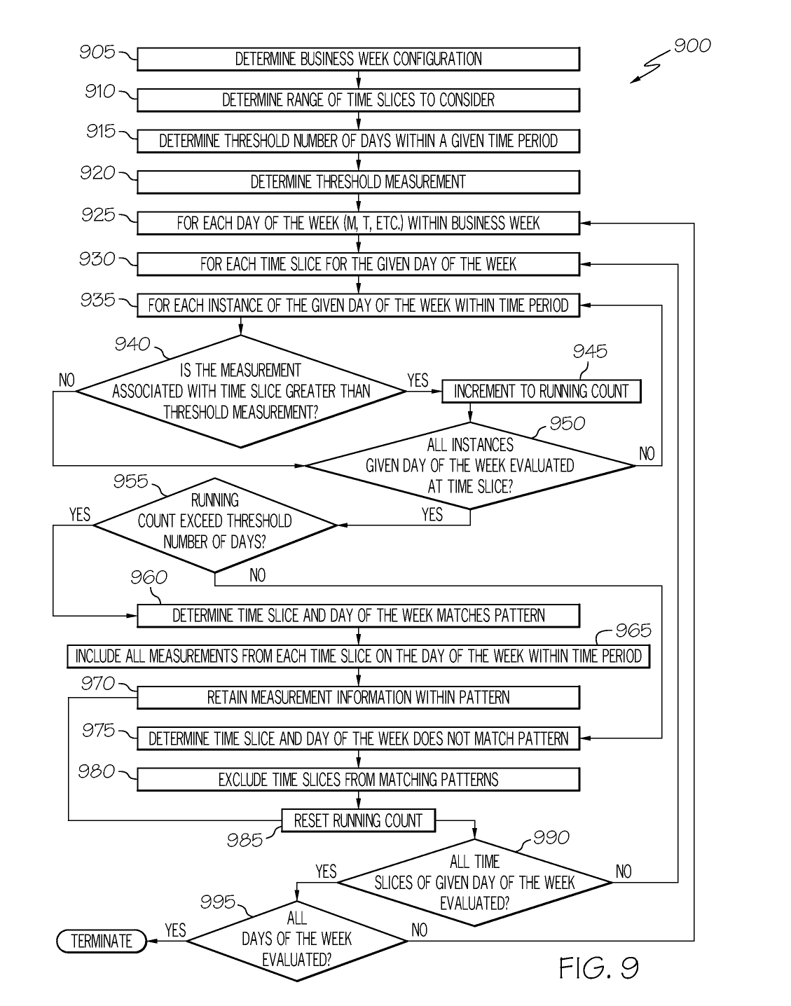

FIG. 9 is an illustration of an example embodiment of a method 900 for pattern matching to determine a repeating hours by business day pattern within a time period. In one embodiment, such a time period may include a month. Method 900 may implement fully or in part step 635 of FIG. 6. In step 905, a business week configuration to be used in the pattern matching of method 800 may be determined. The business week may define the set of days of the week that are to be included within the pattern matching. For example, Monday through Friday, Monday through Saturday, or all seven days of the week may be selected. The selection of the business week may be performed according to resource usage that is to be analyzed with pattern matching.

In step 910, a range of time slices to be considered in the pattern matching of method 900 may be determined. For example, all the time slices within a twenty-four hour period beginning at midnight on a given day may be used. In another example, the time slices from midnight to 2:00 am, and the time slices from 4:00 am to midnight may be used.

In step 915, a threshold number of days within a given time period, such as a month or quarter, may be determined. Such a threshold may define, for a common time slice among the instances of the day of the week (Monday, Tuesday, etc.) within the time period, how many of such days must include a threshold measurement level at the common time slice in order for the business week to match the pattern searched for in method 900. The threshold may be defined in absolute or relative terms, and may include all or a subset of such days.

In step 920, a threshold measurement for evaluating the measurements or analysis associated with individual time slices across such days may be determined. Such a threshold may include, for example, a high or low threshold, beyond which the time slice may be considered for pattern matching. In one embodiment, step 920 may include criteria that the measurement reaches a highest or most severe grouping of measurement values, such as “most severe.”

In step 925, a series of steps may be conducted for each instance of a day of the week (Monday, Tuesday, etc.). Only days of the week (Monday, Tuesday, etc.) as included within the configured business week may be included. Further, the steps may be conducted for each such instance of a day of the week (Monday, Tuesday, etc.) within the time period, which may include, for example, a month or quarter. The series of steps may include steps 930-995. One result of an iteration of step 925 may be a determination of, for the time slices for a given day of the week (Monday, Tuesday, etc.), whether such a combination of time and day of the week matches the pattern searched for by method 900 for one or more such times.

In step 930, a series of steps may be conducted for each time slice on the given day of the week. Such steps may include steps 940-990, which may be repeated for the other time slices on the given day of the week. In step 935, a series of steps may be conducted for each instance of the given day of the week within the time period, such as every Tuesday within the month or quarter. Such steps may include steps 940-985.

Thus, given a time slice on a given instance of a given day of the week, in step 940, it may be determined whether the measurement associated with the time slice exceeds the threshold measurement. If so, then in step 945 a running count of such time slices may be incremented. If not, then method 900 may proceed to step 950.

In step 950, it may be determined whether or not all the instances of the day of the week have been evaluated for the given time slice. If not, method 900 may return to step 835 to evaluate the time slice corresponding to the same time on a subsequent instance of the given day of the week. If so, then in step 955 it may be determined whether the running count of time slices has exceeded the threshold number of days, as determined in step 915. If not, then method 900 may proceed to step 975. If so, then in step 960 it may be determined that the time slice matches repeating hours by business day pattern.

In step 965, all measurements associated with each such time slice across each instance of the given day of the week may be included within the matched pattern. In step 970, measurement information for each such time slice may be retained, whether or not a given time slice measurement exceeded the measurement threshold. Method 900 may proceed to step 985.

In step 975, it may be determined that the time slice does not match repeating hours by business day pattern. In step 980, measurement information for each such time slice among the instances of the given day of the week may be excluded, suppressed, masked or otherwise kept out of the matching pattern. Such a step may be conducted whether or not a given time slice measurement exceeded the measurement threshold.

In step 985, the running count may be reset. In step 990, it may be determined whether all time slices of the given day of the week have been evaluated. If not, then method 900 may return to step 930 to repeat steps for analyzing the other time slices across the instances of a given day of the week. If so, then in step 995, it may be determined whether all days of the week have been evaluated. If not method 900 may return to step 925. If so, method 900 may terminate.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
accessing, on an electronic device, measurement information related to the operation of an electronic device under evaluation, the measurement information comprising analysis of measurements of the operation of the electronic device under evaluation;
dividing the measurement information into time slices;
organizing the measurement information into a calendar chart;
determining a pattern of measurement information, the pattern considering a plurality of the time slices;
providing the measurement information associated with the pattern in the calendar chart at the associated time slices; and
suppressing measurement information unassociated with any determined pattern in the calendar chart.

2. The method of claim 1, wherein:
determining the pattern comprises determining, for a subset of time slices, a most extreme instance of measurement information within the subset of time slices;
providing the measurement information comprises providing the determined most extreme instance of measurement information;
suppressing measurement information comprises suppressing all other measurement information within the subset of time slices; and
the determining, providing, and suppressing are repeated for a plurality of subsets of time slices.

3. The method of claim 1, further comprising:
determining a business week, the business week comprising a plurality of the seven days of the week;
determining a threshold amount of days; and
determining a threshold measurement value;
wherein determining the pattern comprises determining, for a given time period:
determining, for the given time period on each of the days of the business week, whether the measurement information associated with the given time period exceeds the threshold measurement value;
determining the amount of instances of the given time period on each of the days of the business week whose measurement information exceeds the threshold measurement value; and,
based on a comparison of the determined amount of instances with the threshold amount of days, determining that the business week in combination with the given time period matches the pattern.

4. The method of claim 3, wherein:
providing the measurement information associated with the pattern comprises providing the measurement information for each of the instances of the given time period on each of the days of the business week; and
suppressing measurement information comprises suppressing each of the instances of the given time period on each of the days of the business week.

5. The method of claim 1, further comprising:
determining a time period comprising a plurality of instances of each of the seven days of the week;
determining a threshold amount of days;
determining a threshold measurement value; and
determining a day of the week, the day of the week identified as one of the seven days of the week;
wherein determining the pattern comprises determining, for a given time period:
determining, for the given time period on each of the instances of the day of the week, whether the measurement information associated with the given time period exceeds the threshold measurement value;
determining the amount of instances of the given time period on each of the instances of the day of the week whose measurement information exceeds the threshold measurement value; and,
based on a comparison of the determined amount of instances with the threshold amount of days, determining that the day of the week in combination with the given time period matches the pattern.

6. The method of claim 5, wherein:
providing the measurement information associated with the pattern comprises providing the measurement information for each of the instances of the given time period on each of the instances of the day of the week; and
suppressing measurement information comprises suppressing each of the instances of the given time period on each of the instances of the day of the week.

7. The method of claim 1, further comprising determining a business week, the business week comprising a plurality of the seven days of the week, and wherein determining a pattern of measurement information comprises:
determining a pattern from the measurement information from the days included in the business week; and
ignoring the measurement information from the days not included in the business week.

8. A system comprising:
a memory;
a processor coupled to the memory; and
computer-executable instructions within the memory, the instructions readable by the processor, the instructions, when read and executed, for causing the processor to:
access measurement information related to the operation of an electronic device under evaluation, the measurement information comprising analysis of measurements of the operation of the electronic device under evaluation;
divide the measurement information into time slices;
organize the measurement information into a calendar chart;
determine a pattern of measurement information, the pattern considering a plurality of the time slices;
provide the measurement information associated with the pattern in the calendar chart at the associated time slices; and
suppress measurement information unassociated with any determined pattern in the calendar chart.

9. The system of claim 8, wherein:
causing the processor to determine the pattern comprises causing the processor to determine, for a subset of time slices, a most extreme instance of measurement information within the subset of time slices;
causing the processor to provide the measurement information comprises causing the processor to provide the determined most extreme instance of measurement information;
causing the processor to suppress measurement information comprises causing the processor to suppress all other measurement information within the subset of time slices; and
the system further comprises computer-executable instructions to cause the processor to repeat the determining the pattern, the providing the measurement information, and the suppressing measurement information for a plurality of subsets of time slices.

10. The system of claim 8, further comprising computer-executable instructions for causing the processor to:
determine a business week, the business week comprising a plurality of the seven days of the week;
determine a threshold amount of days; and
determine a threshold measurement value;
wherein causing the processor to determine the pattern comprises causing the processor to, for a given time period:
determine, for the given time period on each of the days of the business week, whether the measurement information associated with the given time period exceeds the threshold measurement value;
determine the amount of instances of the given time period on each of the days of the business week whose measurement information exceeds the threshold measurement value; and,
based on a comparison of the determined amount of instances with the threshold amount of days, determine that the business week in combination with the given time period matches the pattern.

11. The system of claim 10, wherein:
causing the processor to provide the measurement information associated with the pattern comprises causing the processor to provide the measurement information for each of the instances of the given time period on each of the days of the business week; and
causing the processor to suppress measurement information comprises causing the processor to suppress each of the instances of the given time period on each of the days of the business week.

12. The system of claim 8, further comprising computer-executable instructions to cause to processor to:
determine a time period comprising a plurality of instances of each of the seven days of the week;
determine a threshold amount of days;
determine a threshold measurement value; and
determine a day of the week, the day of the week identified as one of the seven days of the week;
wherein causing the processor to determine the pattern comprises causing the processor to, for a given time period:
determine, for the given time period on each of the instances of the day of the week, whether the measurement information associated with the given time period exceeds the threshold measurement value;
determine the amount of instances of the given time period on each of the instances of the day of the week whose measurement information exceeds the threshold measurement value; and,
based on a comparison of the determined amount of instances with the threshold amount of days, determine that the day of the week in combination with the given time period matches the pattern.

13. The system of claim 12, wherein:
causing the processor to provide the measurement information associated with the pattern comprises causing the processor to provide the measurement information for each of the instances of the given time period on each of the instances of the day of the week; and
causing the processor to suppress measurement information comprises causing the processor to suppress each of the instances of the given time period on each of the instances of the day of the week.

14. The system of claim 8, further comprising computer-executable instructions for causing the processor to determine a business week, the business week comprising a plurality of the seven days of the week, and wherein causing the processor to determine a pattern of measurement information comprises causing the processor to:
determine a pattern from the measurement information from the days included in the business week; and
ignore the measurement information from the days not included in the business week.

15. A computer program product comprising a computer readable storage medium having computer readable program code embodied therewith, the computer readable program code comprising:
computer readable program code configured to access measurement information related to the operation of an electronic device under evaluation, the measurement information comprising analysis of measurements of the operation of the electronic device under evaluation;
computer readable program code configured to divide the measurement information into time slices;
computer readable program code configured to organize the measurement information into a calendar chart;
computer readable program code configured to determine a pattern of measurement information, the pattern considering a plurality of the time slices;
computer readable program code configured to provide the measurement information associated with the pattern in the calendar chart at the associated time slices; and
computer readable program code configured to suppress measurement information unassociated with any determined pattern in the calendar chart.

16. The computer program product of claim 15, wherein:
the computer readable program code configured to determine the pattern of measurement information comprises computer readable program code configured to determine, for a subset of time slices, a most extreme instance of measurement information within the subset of time slices;
the computer readable program code configured to provide the measurement information comprises computer readable program code configured to provide the determined most extreme instance of measurement information;
the computer readable program code configured to suppress measurement information comprises computer readable program code configured to suppress all other measurement information within the subset of time slices; and
the computer program product further comprises computer readable program code configured to repeat, for a plurality of subsets of time slices, the computer readable program code configured to determine a pattern of measurement information, provide the measurement information associated with the pattern in the calendar chart at the associated time slices, and suppress measurement information unassociated with any determined pattern in the calendar chart.

17. The computer program product of claim 15, further comprising:
computer readable program code configured to determine a business week, the business week comprising a plurality of the seven days of the week;
computer readable program code configured to determine a threshold amount of days; and
computer readable program code configured to determine a threshold measurement value;
wherein the computer readable program code configured to determine the pattern comprises computer readable program code configured to, for a given time period:
determine, for the given time period on each of the days of the business week, whether the measurement information associated with the given time period exceeds the threshold measurement value;
determine the amount of instances of the given time period on each of the days of the business week whose measurement information exceeds the threshold measurement value; and,
based on a comparison of the determined amount of instances with the threshold amount of days, determine that the business week in combination with the given time period matches the pattern.

18. The computer program product of claim 17, wherein:
the computer readable program code configured to provide the measurement information associated with the pattern comprises computer readable program code configured to provide the measurement information for each of the instances of the given time period on each of the days of the business week; and
computer readable program code configured to suppress measurement information comprises computer readable program code configured to suppress each of the instances of the given time period on each of the days of the business week.

19. The computer program product of claim 15, further comprising:
computer readable program code configured to determine a time period comprising a plurality of instances of each of the seven days of the week;
computer readable program code configured to determine a threshold amount of days;
computer readable program code configured to determine a threshold measurement value;
computer readable program code configured to determine a day of the week, the day of the week identified as one of the seven days of the week;
wherein the computer readable program code configured to determine the pattern comprises computer readable program code configured to, for a given time period:
determine, for the given time period on each of the instances of the day of the week, whether the measurement information associated with the given time period exceeds the threshold measurement value;
determine the amount of instances of the given time period on each of the instances of the day of the week whose measurement information exceeds the threshold measurement value; and,
based on a comparison of the determined amount of instances with the threshold amount of days, determine that the day of the week in combination with the given time period matches the pattern.

20. The computer program product of claim 19, wherein:
the computer readable program code configured to provide the measurement information associated with the pattern comprises computer readable program code configured to provide the measurement information for each of the instances of the given time period on each of the instances of the day of the week; and
the computer readable program code configured to suppress measurement information comprises computer readable program code configured to suppress each of the instances of the given time period on each of the instances of the day of the week.

21. The computer program product of claim 15, further comprising computer readable program code configured to determine a business week, the business week comprising a plurality of the seven days of the week, and wherein the computer readable program code configured to determine a pattern of measurement information comprises:
computer readable program code configured to determine a pattern from the measurement information from the days included in the business week; and
computer readable program code configured to ignore the measurement information from the days not included in the business week.
